(19) United States
(12) Patent Application Publication
(10) Pub. No.: US 2026/0319065 A1
(43) Pub. Date: Oct. 15, 2026

(54) SYSTEMS AND METHODS FOR REDUCING THE COMPLEXITY OF A DELAY VANDERMONDE MATRIX OF A BEAMFORMER

(71) Applicants: Habarakada Liyanachchi Prabath Arjuna Madanayake, Miami, FL (US); Sirani Kanchana Mututhanthrige Perera, Miami, FL (US)

(72) Inventors: Habarakada Liyanachchi Prabath Arjuna Madanayake, Miami, FL (US); Sirani Kanchana Mututhanthrige Perera, Miami, FL (US)

(73) Assignee: The Florida International University Board of Trustees, Miami, FL (US)

(21) Appl. No.: 19/095,898

(22) Filed: Mar. 31, 2025

(51) Int. Cl. G01S 7/03; G01S 13/02; G01S 13/42

(52) U.S. Cl. CPC G01S 7/03; G01S 13/426; G01S 2013/0254

(57) ABSTRACT

Systems and methods for reducing the complexity (to O(N)) of a delay Vandermonde matrix (DVM) utilized by a beamformer are provided, along with beamformers utilizing the DVM with a reduced complexity of O(N). The beamformer can be a true time delay (TTD) multi-beam beamformer comprising at least one antenna or antenna array. An approximated DVM (ADVM) algorithm can be used that utilizes highly sparse factors, thereby reducing the gain-delay complexity of the DVM-vector product from O(N²) (or in some cases O(N log N)) to O(N). The reduced complexity ADVM algorithm can be achieved/implemented by using O(N log N) DVM and O(N) approximated discrete Fourier transform (ADFT) algorithms, reducing the gain delay complexity of the DVM algorithm to a linear order.

### GOVERNMENT SUPPORT

This invention was made with government support under 2229471, and 2229473 awarded by the National Science Foundation. The government has certain rights in the invention.

### BACKGROUND

Wideband multi-beam beamforming is essential to meet the ever-expanding range of applications for both frequency range three (FR3) (6 gigahertz (GHz)-24 GHz and frequency range 2 (FR2) (the mm-waves (mmW) in the 24 GHz-300 GHz bands) in next-generation communication systems, wireless networks, and radar systems. For instance, fifth-generation (5G) systems ideally require a frequency range of 30 GHz to 300 GHz while sixth-generation (6G) systems will likely be over the FR3 band. The FR2 and FR3 frequency bands have garnered significant interest as a solution to meet 5G/6G networks' demands for network capacity.

Beamforming is a signal processing method that improves the strength of signals received by antennas by adjusting their amplitude and phase in a manner such that the signal of interest is subject to constructive interference, while radio frequency (RF) interference (RFI) is diminished via destructive interference. This allows for the creation of a stronger beam of signal in the desired direction having improved signal-to-noise and interference ratio (SINR). Beamforming overcomes path loss and therefore enables high-capacity wireless connections to be established even in environments with multiple signal paths. There has been increasing interest in estimating temporal and spatial (directional) parameters. A low-complexity multi-beam beamforming solution can use the approximate discrete Fourier transform (ADFT) with uniformly linear or rectangular arrays. Here, a fast Fourier transform (FFT) like factorization of the ADFT matrix can be used in an algorithm to improve the efficiency of real-time beamformers, reducing circuit complexities and power consumption in comparison to FFT. With the use of ADFT, an N-number of non-overlapping beams could be created for N elements in the array.

The selective directional enhancement of a uniform plane wave based on its direction of propagation constitutes a beamforming operation. For ultrawideband plane waves contaminated by wide sense stationary additive white Gaussian noise (AWGN), the optimal beamformer takes the form of a true time delay-based delay-end-sum operation. For example, to directionally enhance a wideband wave arriving at angle φ measured from the broadside direction from an N—element linear aperture of antennas, the delay and sum operation for beamforming requires the computation of

$$y ( t ) = {\sum }_{k = 1}^{N} {x}_{k} ( t - k τ ) ,$$

where

$$τ = \frac{Δ x}{c} sin ϕ$$

and where Δx is the inter antenna distance and c is the speed of light. A single beam requires N delay elements; thus, N simultaneous beams at arbitrarily chosen angles would naturally lead to N parallel copies of the beamformer thus leading to O(N²) delay elements in total.

### BRIEF SUMMARY

Embodiments of the subject invention provide novel and advantageous systems and methods for reducing the complexity (to O(N)) of a delay Vandermonde matrix (DVM) utilized by a beamformer (e.g., utilized to describe delay and sum operations in beamforming of the beamformer), as well as beamformers utilizing the DVM with a reduced complexity of O(N) (e.g., complexity of no greater than O(N)). The beamformer can be a true time delay (TTD) multi-beam beamformer comprising at least one antenna or antenna array (e.g., radio frequency (RF) antenna or antenna array). An approximated DVM (ADVM) algorithm (e.g., an N-point ADVM) can be used that utilizes highly sparse factors, thereby reducing the gain-delay complexity of the DVM-vector product from O(N²) (or in some cases O(N log N)) to O(N). The reduced complexity ADVM algorithm can be achieved/implemented by using O(N log N) DVM algorithm followed by O(N) approximated discrete Fourier transform (ADFT) algorithms, reducing the gain delay complexity of the DVM algorithm to a linear order. For example, discrete Fourier transform (DFT) matrices can be replaced with ADFT matrices.

In an embodiment, a beamformer can comprise: a plurality of antennas; a plurality of amplifiers respectively connected (e.g., electrically connected and/or directly physically connected) to the plurality of antennas (e.g., RF antennas); a plurality of filters respectively connected (e.g., electrically connected and/or directly physically connected) to the plurality of amplifiers; and a plurality of converters respectively connected (e.g., electrically connected and/or directly physically connected) to the plurality of filters. The beamformer can be a TTD multi-beam beamformer and can utilize a DVM to describe delay and sum operations in beamforming of the beamformer. The DVM utilized by the beamformer can have a complexity of O(N). The plurality of amplifiers can comprise or be a plurality of low noise amplifiers (LNAs). The plurality of filters can comprise or be a plurality of low-pass filters (LPFs). The plurality of filters can comprise or be a plurality of high-pass filters. The plurality of converters can comprise at least one analog-to-digital converter (ADC) (e.g., a plurality of ADCs) and/or at least one digital-to-analog converter (DAC) (e.g., a plurality of DACs). The beamformer can further comprise a chip electrically connected to the plurality of antennas, the plurality of amplifiers, the plurality of filters, and/or the plurality of converters. The chip can be running and/or be configured to run an ADVM algorithm, which can be implemented using DVM algorithm and at least one ADFT algorithm. The beamformer can have a sampling rate (e.g., a Nyquist rate) of at least 1 gigasamples per second (GS/s) (e.g., at least 16 GS/s, at least 32 GS/s, at least 48 GS/s, or at least 64 GS/s). The beamformer can have a bandwidth of at least 1 gigahertz (GHz) (e.g., at least 10 GHz, at least 16 GHZ, at least 20 GHZ, at least 24 GHZ, at least 30 GHZ, or at least 32 GHz). The chip can comprise a processor and/or a machine-readable medium (which can be in operable communication with the processor).

In another embodiment, a method for reducing a complexity of a DVM (that is utilized by a beamformer to describe delay and sum operations in beamforming of the beamformer) can comprise: providing the beamformer (which can comprise any or all of the features discussed in the previous paragraph); electrically connecting a chip to the plurality of antennas, the plurality of amplifiers, the plurality of filters, and/or the plurality of converters; and running an ADVM algorithm on the chip in order to reduce the complexity of the DVM utilized by the beamformer to O(N). The beamformer can be a TTD multi-beam beamformer. The ADVM algorithm can be implemented using at least one ADFT algorithm. The method can further comprise performing sampling using the beamformer, and the beamformer can have a sampling rate as discussed in the previous paragraph.

In another embodiment, a system for reducing a complexity of a DVM (that is utilized by a beamformer to describe delay and sum operations in beamforming of the beamformer) can comprise: a processor; and a machine-readable medium in operable communication with the processor and having instructions stored thereon that, when executed by the processor, perform the following step: running an ADVM algorithm (e.g., the algorithm shown in FIG. 7 or FIG. 8) in order to reduce the complexity of the DVM utilized by the beamformer to O(N). The system can further comprise a chip on which the processor and/or the machine-readable medium is disposed. The beamformer can comprise any or all of the features discussed in the paragraph before the previous paragraph. The ADVM algorithm can be implemented using at least one ADFT algorithm. The instructions when executed can further perform the following step: performing sampling using the beamformer (and the beamformer can have a sampling rate as discussed in the paragraph before the previous paragraph).

### BRIEF DESCRIPTION OF DRAWINGS

FIG. 1 shows a delay Vandemonde matrix (DVM) frequency response for N=16 wideband delay-and-sum (DAS) beams. Each beam is fully wideband and squint free. Here, ωₜ=2πf is the temporal frequency, and ωₓ is the normalized spatial frequency. All 16 beams are shown in the same plot. Beam cross sections take the familiar sinc ωₓ form.

FIG. 2 shows an O(N) wideband direct-digital DVM beamformer, according to an embodiment of the subject invention. This particular beamformer is an 8-channel 0 gigahertz (GHz)-32 GHz O(N) wideband direct-digital DVM beamformer using Intel Altera Agilex 9 Direct-radio frequency (RF) chiplet technology.

FIG. 3 shows a 16-point approximated scaled DVM algorithm (Asdvm16) representing dashed lines for the multiplication by −1, solid lighter (red) lines for the multiplication by j=\sqrt{−1}, dashed lighter (red) lines for the multiplication by −j, \hat{d}ₖ for the k^{th} component of \hat{D}₁₆, and d̆ₓ for the k^{th} component of D̆₃₂. D̆₁₆ and D̆₃₂ are also shown herein.

FIG. 4 shows a table of gain-delay block counts of a scaled approximated DVM algorithm versus the direct scaled DVM by a vector and O(Nlog N) DVM algorithm. With respect to the third column, see also Perera et al. (A fast dvm algorithm for wideband time-delay multi-beam beamformers, IEEE Transactions on Signal Processing, vol. 70, pp. 5913-5925, 2022; which is hereby incorporated by reference herein in its entirety). The “[6]” at the end of the header for the third column can be ignored.

FIG. 5 shows a table of minimizing the difference between exact and approximated scaled DVMs through the spectral norm with the best possible α₁, α∈ [symbol] , where α₁=e^{-j(2q+1)π/2} for q∈ [symbol] . The “9” in the header for the second and fourth columns can be ignored Equation 6 (as presented herein) is relevant to these columns.

FIG. 6 shows a table of gains, delays, and anti-causal counts of a scaled, approximated DVM algorithm.

FIG. 7 shows an approximated scaled DVM algorithm, according to an embodiment of the subject invention. It can also be referred to herein as “Asdvm”, “Algorithm 1” or “Algorithm III.1”.

FIG. 8 shows a 16-point approximated DVM algorithm, according to an embodiment of the subject invention. It can also be referred to herein as “Asdvm16”, “Algorithm 2” or “Algorithm III.2”.

FIG. 9 shows a DVM algorithm, according to an embodiment of the subject invention. It can also be referred to herein as “Algorithm 3” or “Algorithm III.3”.

FIG. 10 shows a DVM algorithm, according to an embodiment of the subject invention. It can also be referred to herein as “Algorithm 4” or “Algorithm III.4”.

### DETAILED DESCRIPTION

Embodiments of the subject invention provide novel and advantageous systems and methods for reducing the complexity (to O(N)) of a delay Vandermonde matrix (DVM) utilized by a wideband multi-beam beamformer (e.g., utilized to describe delay and sum operations in beamforming of the beamformer), as well as beamformers utilizing the DVM with a reduced complexity of O(N) (e.g., complexity of no greater than O(N)). The beamformer can be a true time delay (TTD) multi-beam beamformer comprising at least one antenna or antenna array (e.g., radio frequency (RF) antenna or antenna array). An approximated DVM (ADVM) algorithm (e.g., an N-point ADVM) can be used that utilizes highly sparse factors, thereby reducing the gain-delay complexity of the DVM-vector product from O(N²) (or in some cases O(N log N)) to O(N). The reduced complexity ADVM algorithm can be achieved/implemented by using O(N log N) DVM algorithm followed by O(N) approximated discrete Fourier transform (ADFT) algorithms, reducing the gain delay complexity of the DVM algorithm to a linear order. For example, discrete Fourier transform (DFT) matrices can be replaced with ADFT matrices.

Recent advances in beamforming techniques and silicon integrated circuit (IC) technology have led to the development of high-bandwidth active beamforming systems. These systems are becoming increasingly attractive alternatives, especially in 5G/6G systems that aim to maximize the available bandwidth of up to 300 gigahertz (GHz) to enhance system capacity. To achieve this, true time-delay-based (TTD) multi-beam beamformers are crucial, and these can be mathematically modeled using a DVM multi-beam algorithm. DVM beamformers are based on TTD approaches, and thus are squint-free and wideband in frequency response. However, DFT beamformers are narrow-band and suffer from beam squint as a function of temporal frequency. To wit, DVM beamformers are needed for emerging wideband systems, while legacy systems that are relatively narrowband in temporal frequency response can use DFT beamformers via FFT algorithms. As wideband systems that operate over extreme frequency ranges become more prevalent, DVM beamformers will be needed as DFT/FFT beamformers suffer from the beam squint (frequency dependence in beam direction) problem.

The TTD multi-beam beamformer has extensive applications in wireless communications and radio frequency (RF) sensing. Related art TTD multi-beam beamformers have circuit complexity that grows as O(N²) for N beams for N-element antenna arrays. Embodiments of the subject invention can reduce it to O(N) (i.e., such that the TTD multi-beam beamformer has circuit complexity that grows as O(N)). The circuit and computational complexity reduction of TTD multi-beam radio frequency (RF) antenna array beamformers from quadratic O(N²) to linear O(N) have extensive applications for low power, low complexity RF and wireless systems for commercial wireless, defense, and scientific markets.

DFT beamformers are realized via Fourier transforms (FFTs). Variants of the Cooley-Tukey FFT algorithm are widely acclaimed for its effectiveness in handling band-limited and sample discrete-domain signals via efficient computation of DFTs. The Cooley-Tukey FFT algorithm significantly diminishes multiplicative complexity, allowing for enhanced computation speed. FFT applications encompass such areas as artificial intelligence (AI)/machine learning (ML) computations and beamforming in radar and mm-Wave wireless network systems. In contrast, the ADFT reduces the multiplicative complexity while preserving its final additive complexity at O(N log N). This makes ADFT algorithms well-suited for applications in narrowband and wideband beamforming. By employing ADFTs instead of FFTs, these networks can possibly reduce the required computational operations, which in turn helps reduce overall circuit complexity, chip area, and power consumption. The ADFT block contains a certain amount of computational error that prevents or inhibits it from producing an exact discrete Fourier transform (DFT). Nevertheless, the practical radio/wireless multi-beam beamforming applications of the vast majority of ADFT algorithms can tolerate these small errors without significantly affecting performance. For instance, ADFT beamformers have worst-case sidelobe levels degraded by about 1.5 decibels (dB) compared to DFT beamformers.

As the size of the matrices increases, the DVM algorithm requires nearly 60% fewer addition and multiplication counts compared to other beamforming techniques, such as brute-force matrix-vector computation (see also, Perera et al., Wideband n-beam arrays with low-complexity algorithms and mixed-signal integrated circuits, IEEE Journal of Selected Topics in Signal Processing, vol. 12, no. 2, pp. 368-382, 2018; which is hereby incorporated herein by reference in its entirety). The DVM is a superclass of the DFT matrices, and it lacks periodic and unitary properties. Nevertheless, stable and O(N log N) DVM algorithms can be used for narrowband multibeam beamforming. Also, the nodes of the Vandermonde matrices can be a special case (i.e., complex nodes can be equally spaced on the unit circle (not necessarily the primitive roots of unity) and any other circle having a radius more than the unity). An O(N log N) DVM algorithm can enable truly wideband multibeam beamforming (see also Perera et al., A fast dvm algorithm for wideband time-delay multi-beam beamformers, IEEE Transactions on Signal Processing, vol. 70, pp. 5913-5925, 2022; which is hereby incorporated by reference herein in its entirety, and which is also cited in the Brief Description of the Drawings). Embodiments of the subject invention provide a way to get the DVM algorithm complexity down to O(N), which can include caveats via approximated computation methods that replace O(N log N) FFTs with factorized ADFTs that are O(N).

Formation of N simultaneous true-time delay-and-sum (DAS) RF beams from an N-element array of wideband antennas has many applications in wireless communications, electronic warfare, spectrum sensing, radar, and signals intelligence. A conventional DAS wideband beamformer scales as O(N²) different individual delay line segments (i.e., the delay complexity), which makes large arrays with many antennas and wideband beams impractical.

Embodiments of the subject invention provide systems and methods based on the factorization of the approximate DFT matrix that reduces the delay complexity from O(N²) to O(N), which in turn makes dense aperture antenna arrays with large N elements lead to N DAS beams at significantly smaller delay line count. Each delay can be realized in a digital signal processor (DSP) as a finite impulse response (FIR) filter. Therefore, a wideband N-beam system at O(N) delay line complexity as opposed to O(N²) leads to a significant reduction and hence a smaller chip area and power consumption for hardware realization on a digital chip (e.g., an application specific integrated circuit (ASIC) chip). In an embodiment, an 8-beam DAS digital multi-beam beamformer using state-of-the-art (SOTA) Agilex-9 Direct-RF chiplets from Intel can support sample rates up to 64 gigasamples per second (GS/s) per channel.

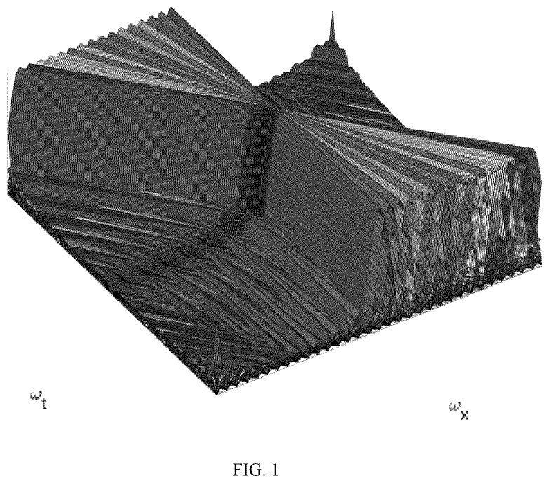

The N×N DVM N-beam beamformer is a special case of beamformer where each p=1, 2, . . . , N beam is realized by integer multiple delays of τₚ=pτ/N². The frequency responses (beam shapes) of the DVM for N=16 beams are shown in FIG. 1. The straightforward realization of N-beams using the DVM-vector operation leads to a parallel hardware realization that essentially uses N² delays. The circuit complexity associated with this multi-beam receiver/transmitter thus scales as O(N²); such a “quadratic complexity” makes scaling to a large number of beams from a high valued N (dense aperture arrays) extremely challenging. To address this problem, a new class of DVM beamforming algorithms can factor the matrix-vector product into a sequence of sparse matrices-vector products so that the net number of delays is reduced to O(N log N), where N=2^{r}(r≥2); this is the same

$$\frac{log N}{N}$$

factor of reduction, albeit for the number of delays just like for the case of applying FFTs in place of direct matrix-vector operations when one is computing a discrete Fourier transform (DFT). FFTs exhibit butterfly networks in their signal flow graph representations (see also Perera et al., 2022, supra.).

Embodiments of the subject invention provide DVM wide-band multi-beam beamforming algorithms that achieve N-wideband beams at linear complexity; that is, the DVM beamformer requires only O(N) delays to realize N-beams. The realized beams are within about 2 decibels (dB) of the ideal DVM beams in their directional selectivity. This massive reduction can be achieved by starting from the O(N log N) DVM multi-beam algorithm that makes use of the exact-DFT (see also Perera et al., 2022, supra. (cited in the previous paragraph)). The DVM in Perera et al., 2022 (supra.) can be replaced with an approximate DFT instead (see also; Madanayake et al., Design of multichannel spectrum intelligence systems using approximate discrete Fourier transform algorithm for antenna array-based spectrum perception applications, Algorithms, vol. 17, no. 8, 2024, mdpi.com/1999-4893/17/8/338; Cintra et al., Fast radix-32 approximate dfts for 1024-beam digital rf beamforming, IEEE Access, vol. 8, pp. 96 613-96 627, 2020; and Ariyarathna et al., Towards a low-swap 1024-beam digital array: A 32-beam subsystem at 5.8 ghz, IEEE Transactions on Antennas and Propagation, vol. 68, no. 2, pp. 900-912, 2020; all three of which are hereby incorporated by reference herein in their entireties). An exact DFT can be realized at O(N log N) via FFTs while the approximate DFT has a corresponding matrix sparse factorization that exhibits O(N) delays in DVM aggregated across its butterfly networks. Therefore, even though there is a small (1.5 dB or less) loss of directional selectivity, a massive reduction in the number of true time delay (TTD) circuits can be achieved while still obtaining N-simultaneous beams.

The DVM can be explicitly defined by

$${A}_{N} := {[ {A}_{kl} ]}_{N} = {[ {α}^{kl} ]}_{k = 1 , l = 0}^{N , N - 1} ,$$

where N=2^{r}(r≥1), {α, α², . . . α^{N}} are distinct complex nodes s.t. α=e^{-jωτ},j²=−1, ω is the temporal frequency, and τ is the delay (see also; Perera et al., Wideband n-beam arrays with low-complexity algorithms and mixed-signal integrated circuits, IEEE Journal of Selected Topics in Signal Processing, vol. 12, no. 2, pp. 368-382, 2018; Perera, Madanayake, and Cintra, Efficient and self-recursive delay Vandermonde algorithm for multi-beam antenna arrays, IEEE Open Journal of Signal Processing, vol. 1, no. 1, pp. 64-76, 2020; and Perera, Madanayake, and Cintra, Radix-2 Self-recursive Algorithms for Vandermonde-type Matrices and True-time-delay Multi-beam Antenna Arrays, IEEE Access, vol. 8, pp. 25498-25508, 2020; all three of which are hereby incorporated by reference herein in their entireties). The scaled DVM (i.e., scaling with respect to a diagonal matrix) is defined as

$${\tilde{A}}_{N} := {[ {\tilde{A}}_{kl} ]}_{N} = {[ {α}^{kl} ]}_{k , l = 0}^{N - 1} .$$

The coefficient α^{kl} is a temporal Fourier transform of a pure time-delay of duration τ. The signal x(t) with Fourier transform X(ω) is related to the delayed version of the signal x(t−pτ) via the relationship X(ω)e^{-jpωτ}. Thus, the corresponding phase rotation of X(ω) is simply α^{p}=e^{-jpωτ}. Crucially, the DVM contains closed-form complex functions of ω given as complex phase rotations in integer powers p of α. That is, α^{p} are not numerical values; they are complex functions of frequency ω raised to power p. Hence, an N×N DVM containing powers of α looks like a matrix-vector product, but this is in the temporal Fourier domain, so this is defined O(N²) number of delay-and-sum dot product, not the usual O(N²) number of multiply-and-sum dot product.

Mathematical techniques exist to derive radix-2 and split-radix FFT algorithms (see also; Cooley and Tukey, An algorithm for the machine calculation of complex Fourier series,” Math. Comp., vol. 19, pp. 297-301, 1965; Yavne, An economical method for calculating the discrete fourier transform, in in Proc. AFIPS Fall Joint Computer Conf. 33, 1968, pp. 115-125; Strang, Introduction to Applied Mathematics, USA: Wesley-Cambridge Press, 1986; Loan, Computational Frameworks for the Fast Fourier Transform, Philadelphia, USA: SIAM Publications, 1992; Johnson et al., A modified split-radix fft with fewer arithmetic operations,” IEEE Trans., vol. 55, no. 1, p. 111-119, 2007; Rao et al., Fast Fourier Transform: Algorithm and Applications. New York, USA: Springer, 2010; and Blahut, Fast Algorithms for Signal Processing, Cambridge University Press, 2010, api.semanticscholar.org/CorpusID:53846853; all seven of which are hereby incorporated by reference herein in their entireties; see also Perera et al., 2022, supra.). Even though the derivation of size-N DFT into two size-N DFTs can be done easily, the extension of this idea to the DVM is cumbersome because the useful DFT matrix properties, like periodicity and unitary, are not present in the DVM. Consequently, considering these mathematical properties and the representation of DVM elements through TTD wideband multi-beam, unlike the narrowband representation characterized by the FFT-beams, it becomes evident that DVM serves as a superclass of DFT matrices.

Various DVM algorithms can be designed to accurately compute the exact DVM-vector product for both narrowband and wideband communication systems. Perera et al., 2022 (supra.) presents a derivation of the DVM algorithm, successfully reducing the complexity of RF N-beam analog beamforming systems from O(N²) to O(N log N). While some DVM algorithms show greater efficiency compared to brute-force matrix-vector calculations, their arithmetic complexity remains substantially higher than O(N log N). On the other hand, numerically stable DVM algorithms with complexity of O(N log N) apply to Vandermonde matrices with nodes positioned on the unit circle (not exclusively at the roots of unity) and also on circles with their center at the origin and a radius exceeding one (see also, Perera, Madanayake, and Cintra, Radix-2 Self-recursive Algorithms for Vandermonde-type Matrices and True-Time-Delay Multi-Beam Antenna Arrays, IEEE Access 8, 2020). Unlike some DVM algorithms that are specifically designed for narrowband communication systems, the radix-2 DVM algorithm is tailored for TTD wideband communication systems.

Embodiments of the subject invention can use sparse factors to compute an approximate DVM (ADVM) using a 16-point DVM followed by approximate DFT to reduce delay complexity from quadratic to linear. Before stating the factorization formula for the ADVM, the factorization leading O(N log N) DVM algorithm will be discussed.

The scaled DVM factorization resulting in an O(N log N) DVM algorithm executes based on the DVM factorization defined below (see also Perera et al., 2022, supra.)

$${\tilde{A}}_{N} = {{\hat{D}}_{N} [ {J}_{M \times N} ]}^{T} {F}_{M}^{*} {{D}^{⌣}}_{M} {F}_{M} {J}_{M \times N} {\hat{D}}_{N} ,$$

where

$$M = 2 N , {J}_{M \times N} = [ \frac{{I}_{N}}{{0}_{N}} ]$$

is a highly sparse matrix containing the identity matrix I_{N} and the zero matrix O_{N}, ^{T} denotes the transpose of matrices. The matrices

$${D}_{N} = {diag [ {α}^{k} ]}_{k = 0}^{N - 1} , {\hat{D}}_{N} = {diag [ {α}^{\frac{{k}^{2}}{2}} ]}_{k = 0}^{N - 1}$$

and D̆_{M}=diag [\tilde{F}_{M}C] and diagonal matrices, and a circulant matrix

$${C}_{M} := {F}_{M}^{*} {{D}^{⌣}}_{M} {F}_{M} ,$$

which is defined by the first column

$$c s . t . c = {[ 1 , {α}^{- \frac{1}{2}} , … , {α}^{- \frac{{( N - 1 )}^{2}}{2}} , 1 , {α}^{- \frac{{( N - 2 )}^{2}}{2}} , … , {α}^{- \frac{1}{2}} ]}^{T} .$$

The DFT matrix is defined by

$${F}_{N} = {\frac{1}{\sqrt{N}} [ {w}_{N}^{kl} ]}_{k , l = 0}^{N - 1}$$

having the primitive N^{th} roots of unity

$${w}_{N} = {e}^{- \frac{2 π j}{N}}$$

as the nodes of the DFT matrix. The scaled DFT matrix is denoted by \tilde{F}_{N}=\sqrt{N}F_{N}.

It is important to highlight that the O(N log N) DVM algorithm in Perera et al., 2022 (supra.) executes recursively utilizing the well-known FFTs in Cooley and Tukey (supra.) and Yavne (supra.).

Following the discussion on implementing the DVM algorithm 16-point DVM followed by multiplierless approximated 16-point and 32-point DFT matrices can be computed, having a product of highly sparse matrices (see also; Coelho et al., Multibeam digital array receiver using a 16-point multiplierless dft approximation, IEEE Transactions on Antennas and Propagation, vol. 67, no. 2, pp. 925-933, 2019; and Mandal et al., Towards a low-swap 1024-beam digital array: A 32-beam subsystem at 5.8 ghz, IEEE Transactions on Antennas and Propagation, vol. 68, pp. 900-912, 2020, api.semanticscholar.org/CorpusID:203035738; both of which are hereby incorporated herein by reference in their entireties). The approximate DFT factorization can then be embedded into the DVM algorithm in Perera et al., 2022 (supra.) to reduce the complexity of computing the DVM-vector product, reducing it from O(N²) to O(N).

Building on the DVM factorization and multiplierless approximate DFT factorization, a factorization can be stated to approximate DVM (see also, Perera et al., Linear order approximate-dvm algorithm for true time-delay multi-beam beamforming, IEEE Transactions on Signal Processing, 2024; which is hereby incorporated by reference herein in its entirety).

Proposition 2.2: Let the scaled DVM

$${Ã}_{N} = {[ {α}^{k l} ]}_{k , l = 0}^{N - 1}$$

be defined by nodes {1, α, α², . . . , α^{N-1}}∈ [symbol] , N=2^{r} (r≥3) and M=2N. Then, an approximation for the scaled DVM denoted as Â_{N} by vector x∈ [symbol] or [symbol] , i.e., y=Â_{N}x can be computed through the following:

$$y = {\hat{A}}_{N} x = {{\hat{D}}_{N} [ {J}_{M \times N} ]}^{T} {\hat{F}}_{M}^{{}_{*}} {\breve{D}}_{M}^{} {\hat{F}}_{M}^{} {J}_{M \times N} {\hat{D}}_{N}^{} x ,$$

where \hat{F}_{N} is the approximate DFT matrix (see also Perera et al., 2024, supra.).

If it is assumed that multiplierless approximated DFT matrices were utilized in computing the approximated scaled DVM-vector product in Proposition 2.2, then the explicit delay complexity in computing the scaled DVM-vector product is 4N−2, which in turn has O(N) complexity.

Further, by following the multiplierless 16-point and 32-point DFT algorithms, compute the approximated scaled DVM-vector product can be explicitly computed with 6N−6, 8N−14, and 10N−30 when N=32, 64,128 (see also Coelho et al., supra., and Mandal et al., supra.). Thus, by following a series of complexity counts, it can be stated that the approximated scaled DVM-vector product has the linear order (i.e., multiplication complexity of O(N)) as opposed to the FFT-like O(N log N) complexity algorithms, for N=16 to 1024. On the other hand, the DVM-vector product calculates an approximated DVM algorithm as opposed to the exact DVM algorithms, but with O(N) complexity.

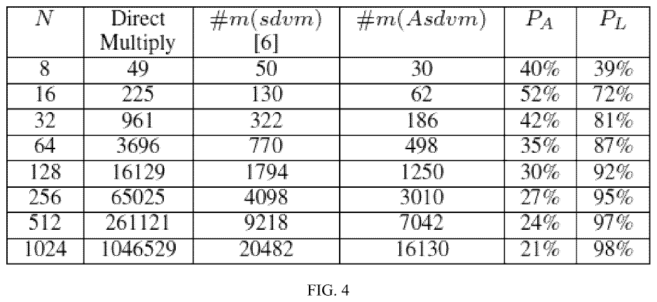

Wideband low-noise amplifiers (LNAs) and Vivaldi antennas must cover the frequency span of up to 32 GHz as this is a direct-digital architecture. Design of such components can be difficult and very expensive to procure. For example, the LNA ZVA-0.5W303GX+ from MiniCircuits covers up to 30 GHz, with gain of and noise figure 4.2 dB, and can be used as a transmit device. Similarly, MiniCircuits LVA-273PN-DG+ has frequency response up to 26.5 GHz, noise figure of about 10 dB, and gain of around 18 dB. The design of the front-end with up to eight such amplifiers can be difficult as these amplifiers cost several thousand dollars per unit and therefore careful optimized and cost-minimum design is a crucial requirement.

The signals of interest can be assumed to be of immense bandwidth, typically on the order of Fₛ/2=B=32 GHz per channel. Sampling such wideband signals requires special circuitry as a single analog-to-digital converter (ADC) typically would not be able to sample, hold, and quantize such bandwidth at reasonable levels of precision and power consumption. A time-interleave ADC with P parallel time-interleaved ADC sub-circuits can be assumed. Each of these P sub-ADCs can be further assumed to undergo temporal decimation by factor L such that the total number of parallel digital channels on the digital signal processor (DSP) would be PL and the digital clock period would be

$${F}_{C l k} = \frac{{F}_{s}}{P L} .$$

For example, assuming a channel bandwidth of 32 GHz and a Nyquist rate of Fₛ=64 GS/s, and a P=16 phase time-interleaved ADC, each sub-ADC will be sampling at 4 GS/s, with the DSP operating at F_{Clk}=256 MHz for a temporal decimation factor of L=16.

The digital delays operate within the field programmable gate array (FPGA) or application specific integrated circuit (ASIC) fabric at a sample rate of F_{Clk} megahertz (MHz), over PL parallel channels that make up the multirate-DSP core that must finally realize any fractional delays or dot-products that are needed for the realization of the matrix analysis required in DVM wideband beamforming in real-time. The basic principle is as follows: let τᵤ be a fractional delay filter, which implies 0≤τᵤ<1 with reference to the full-scale clock Fₛ GHz. A delay τᵤ causes a phase rotation in the frequency domain exp(−jωτᵤ), where ω is the normalized frequency variable with reference to the master sample rate Fₛ GHz.

An M-th order FIR can be designed and realized as a multirate filter to achieve the necessary fractional time sample delays. Typically, multiplications are directly correlated to filter order M that is required for the FIR filter for high bandwidth and precise operation, thereby causing FIR delays to be a major factor for complexity in multi-beam systems. In the design, with PL=256, it can be assumed that M=16 for a reasonable reference design. The block-wise computation of the order-M FIR fractional delay filter (an interpolation operation between integer multiples of the clock at frequency Fₛ) can be realized as a matrix-vector product of the form y=Tx where T is a banded Toeplitz matrix.

The structure of the banded Toeplitz matrix lends itself well for FFT-based computation and can be realized using the maximally-decimated uniform-DFT polyphase filterbank approach to efficient FIR filter realization. Here, the number of phases is PL=256, thus leading to a massively parallel digital architecture.

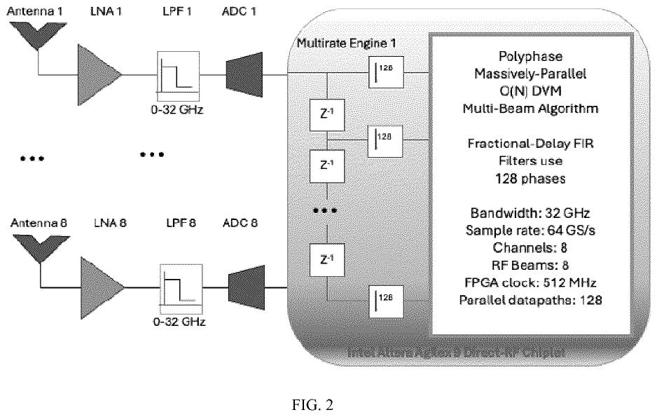

In the past, fully digital realizations of wideband beam-forming networks that operate over multi-GHz bandwidths have been only a dream due to the lack of ADC/digital-to-analog converter (DAC) and fast DSP technologies. However, recent innovations including the Series 9 Direct-RF Agilex system on chip (SoC) using multi-chiplets packaged together, offer exciting possibilities for multi-beam wideband DVM beamformers that span the legacy bands up to 7 GHz (FR1), and upper mid-band (7 GHz-24 GHz) and frequency range two (24 GHz-32 GHz) in a single antenna system and DSP platform. The low-complexity O(N) linear delay-complexity digital DVM algorithm of embodiments of the subject invention is a key enabler that, when coupled with the latest direct-RF chiplets, leads to a new realm of possibilities for fully digital broadband antenna aperture arrays. The Series 9 Agilex Direct-RF chiplets offer 8 ADCs, 8 DACs, and an FPGA device on the same package, where each DAC/DAC can operate up to 64 GS/s (bandwidth of 32 GHz) (see also FIG. 2).

Embodiments of the subject invention can utilize ADFT matrices (see also, Coelho et al., supra., Cintra et al., supra., and Mandal et al., supra.), which allows for the embedding of highly sparse and multiplierless ADFT into the O(N log N) complexity exact DVM algorithm from Perera et al., 2022 (supra.). This can result in the development of linear order approximated DVM algorithms ranging from 8-point to 1024-point. Additionally, an approximate DVM (ADVM) can be obtained that requires minimal multiplication (or analog delay) operations (see also; Silva et al., Inductorless analog time-delays for nonlinear RF signal processing circuits in 180 nm cmos, in 2023 IEEE Microwaves, Antennas, and Propagation Conference (MAPCON), 2023, pp. 1-5; which is hereby incorporated by reference herein in its entirety). A main reason for proposing a linear order DVM algorithm is to reduce the chip area and power consumption in IC design; specifically in the context of wideband multibeam beamforming, the number of delays must be minimized. To pave the way for that, the signal flow graph (SFG) can be demonstrated for the approximated 16-point DVM algorithm (16-point ADVM). Although multiple different DVM algorithms exist, the DVM factorization presented in Perera et al., 2022 (supra.) can be used because it is the exact radix-2 DVM algorithm that executes recursively with the DFT to realize wideband multibeam beamformers.

The DVM can be defined as:

$${A}_{N} := {[ {A}_{kl} ]}_{N} = {[ {α}^{k l} ]}_{k = 1 , l = 0}^{N , N - 1} ,$$

where N=2^{r}(r≥1), {α,α², . . . , α^{N}} are distinct complex nodes s.t. α=e^{-jωτ}, j²=−1, ω is the temporal frequency, and τ is the delay. The scaled DVM (by a diagonal matrix) can be defined as:

$${Ã}_{N} := {[ {Ã}_{kl} ]}_{N} = {[ {α}^{k l} ]}_{k , l = 0}^{N - 1} .$$

The coefficient α^{kl} is a temporal Fourier transform of a pure time-delay of duration τ. The signal x(t) with Fourier transform X(ω) is related to the delayed version of the signal x(t−pτ) via the relationship X(ω)e^{-jpωτ}. Hence, the corresponding phase rotation of X(ω) is simply α^{p}=e^{-jωpτ}. Crucially, the DVM contains closed-form complex functions of ω given as complex phase rotations in integer powers p of α. That is, α^{p} are not numerical values; they are complex functions of frequency ω raised to power p.

Thus, an N×N DVM containing powers of a looks like a matrix-vector product, but this is in the temporal Fourier domain, so this is defined O(N) number of delay-and-sum dot product, not the usual O(N) number of multiply-and-sum dot product.

The DFT matrix can be defined as

$${F}_{N} = {\frac{1}{\sqrt{N}} [ {w}_{N}^{kl} ]}_{k , l = 0}^{N - 1} .$$

A scaled DFT matrix can be defined as \tilde{F}_{N}=\sqrt{N}F_{N}, and the DFT factorization can be given

$${\tilde{F}}_{N} = {P}_{N}^{T} [ \begin{matrix}{F}_{\frac{N}{2}} & {0}_{\frac{N}{2}} \\ {0}_{\frac{N}{2}} & {F}_{\frac{N}{2}}\end{matrix} ] {H}_{N} ,$$

where for a given vector x=[x₀, x₁, . . . , x_{N-1}]^{T}∈R^{N}, an even-odd permutation matrix P_{N} (N≥3) is given via

$${P}_{N} x = \{ \begin{matrix}{[ {x}_{0} , {x}_{2} , … , {x}_{N - 2} , {x}_{1} , {x}_{3} , … , {x}_{N - 1} ]}^{T} & even N \\ {[ {x}_{0} , {x}_{2} , … , {x}_{N - 1} , {x}_{1} , {x}_{3} , … , {x}_{N - 1} ]}^{T} & odd N ,\end{matrix}$$

the scaled orthogonal matrix is given by

$${H}_{N} = [ \begin{matrix}{I}_{\frac{N}{2}} & {I}_{\frac{N}{2}} \\ {{D}^{`}}_{\frac{N}{2}} & - {{D}^{`}}_{\frac{N}{2}}\end{matrix} ] ,$$

the diagonal matrix is given by

$${{D}^{`}}_{\frac{N}{2}} = {diag [ {w}_{N}^{{}_{l}} ]}_{l = 0}^{\frac{N}{2} - 1} ,$$

the identity matrix is given by I_{N}, and the zero matrix is via 0_{N}.

The scaled DVM factorization in Perera et al., 2022 (supra.) can be defined as

$${\tilde{A}}_{N} = {{\hat{D}}_{N} [ {J}_{M \times N} ]}^{T} {F}_{M}^{*} {\breve{D}}_{M} {F}_{M} {J}_{M \times N} {\hat{D}}_{N} ,$$

where

$$M = 2 N , {J}_{M \times N} = [ \frac{{I}_{N}}{{0}_{N}} ]$$

is a highly sparse matrix, diagonal matrices by

$${D}_{N} = {diag [ {α}^{k} ]}_{k = 0}^{N - 1} , {\hat{D}}_{N} = {diag [ {α}^{\frac{{k}^{2}}{2}} ]}^{N - 1} ,$$

and D̆_{M}=diag[\tilde{F}_{M}c], a circulant matrix C_{M} defined by the first column c.s.t.

$$c = {[ 1 , {α}^{- \frac{1}{2}} , … , {α}^{- \frac{{( N - 1 )}^{2}}{2}} , 1 , {α}^{- \frac{{( N - 1 )}^{2}}{2}} , {α}^{- \frac{{( N - 2 )}^{2}}{2}} , … , {α}^{- \frac{1}{2}} ]}^{T} .$$

Let N-point ADFT be defined as \hat{F}_{N}. Coelho et al. (supra.) presents an approximation of the 16-point DFT s.t. \hat{F}₁₆ is expressed as a product of highly sparse matrices factors, and is given via \hat{F}₁₆=P₂·B₅·P₁·D·B₄·B₃·B₂·B₁. Also, Mandal et al. (supra.) provides an approximation of the 32-point DFT, s.t., \hat{F}₃₂=W₈·W₇·W₆·W₅·W₄·W₃·W₂·W₁.

Proposition II.1—The 32-point approximated DFT factorization can be given via

$${\hat{F}}_{32} = {S}_{4} \cdot {S}_{3} \cdot {S}_{2} \cdot {S}_{1} \cdot {S}_{0} , \qquad ( 1 )$$

where S₀=W₁, S₁=W₃·W₂, S₂=W₅·W₄, S₃=W₇·W₆, and S₄=Wₛ(see also Mandal et al., supra.).

Proof. This is trivial by the matrix multiplication while setting S₁=W₃·W₂, S₂=W₅·W₄, and S₃=W₇·W₆ in Mandal et al. (supra.). These Sᵢ matrices for i=0, 1, . . . , 4, are explicitly given as follows.

The explicit factorization for \hat{F}₃₂, where \hat{F}₃₂=S₄·S₃·S₂·S₁·S₀, will now be presented. Let the matrices in the factorization of \hat{F}₃₂ be defined as

$${S}_{0} = [ \begin{matrix}{S}_{0 , 11} & {0}_{17} \\ {0}_{15} & {S}_{0 , 22}\end{matrix} ] ,$$

where the block submatrices S_{0,11} and S_{0,22} are given via

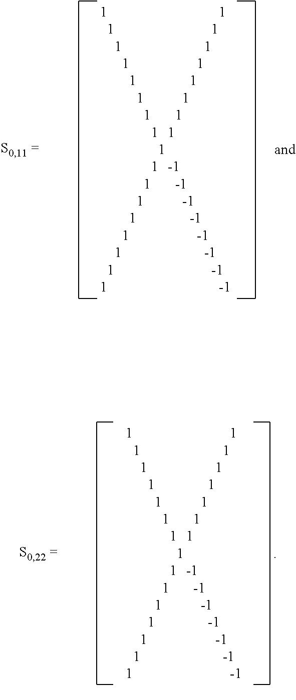

The S₁ matrix is defined as

$${S}_{1} = [ \begin{matrix}{S}_{1 , 11} & {S}_{1 , 12} \\ {S}_{1 , 21} & {S}_{1 , 22}\end{matrix} ] ,$$

where the block submatrices S_{1,11}, S_{1,12}, S_{1,21}, and S_{1,22} are given via

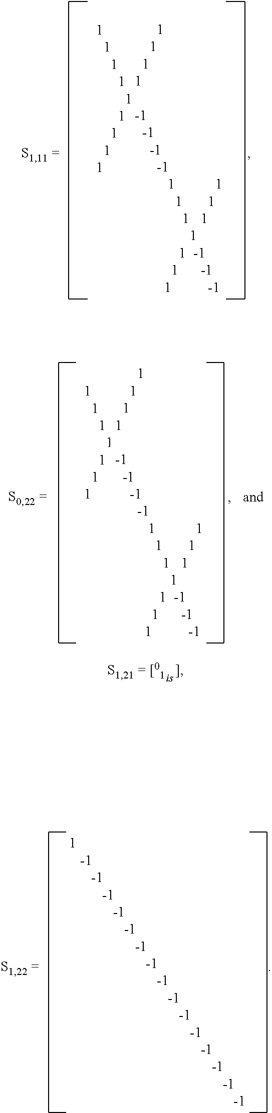

The S₂ is defined as

$${S}_{2} = [ \begin{matrix}{S}_{2 , 11} & {0}_{16} \\ {0}_{16} & {S}_{2 , 22}\end{matrix} ] ,$$

where the block submatrices S_{2,11} and S_{2,22} are given via

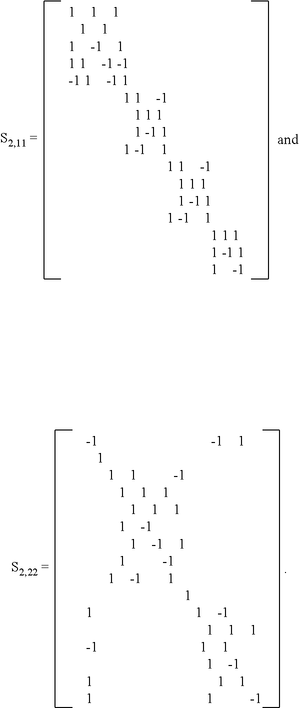

The S₃ is defined as

$${S}_{3} = [ \begin{matrix}{S}_{3 , 11} & {0}_{16} \\ {0}_{16} & {S}_{3 , 22}\end{matrix} ] ,$$

where the block submatrices S_{3,11} and S_{3,22} are given via

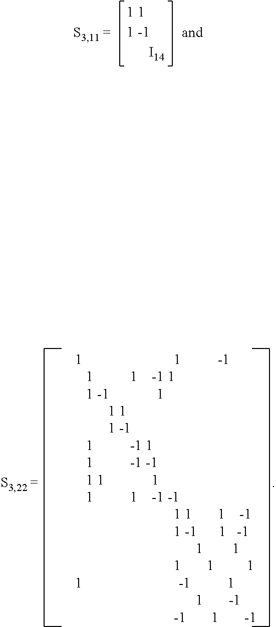

The S₄ matrix is defined as

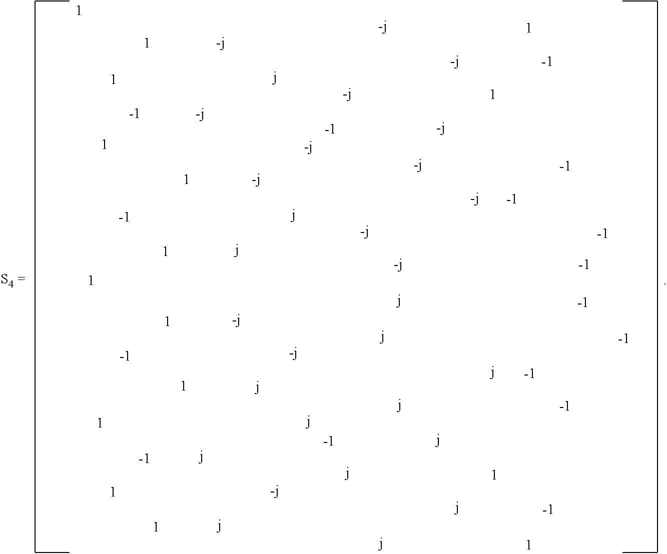

The explicit approximated 32-point DFT matrix can be denoted as follows

$${\hat{F}}_{32} = [ \begin{matrix}{F}_{32 , 11} & {F}_{32 , 12} \\ {F}_{32 , 21} & {F}_{32 , 22}\end{matrix} ] , \\ where$$

$${F}_{32 , 11} = [ \begin{matrix}1 & 1 & 1 & 1 & 1 & 1 & 1 & 1 & 1 & 1 & 1 & 1 & 1 & 1 & 1 & 1 \\ 1 & 1 & 1 & 1 - j & 1 - j & 1 - j & - j & - j & - j & - j & - j & - 1 - j & 1 - j & 1 - j & - 1 & - 1 \\ 1 & 1 & 1 - j & - j & - j & - j & - 1 - j & - 1 & - 1 & - 1 & - 1 + j & j & j & j & 1 + j & 1 \\ 1 & 1 - j & - j & - j & - 1 - j & - 1 & - 1 & - 1 + j & - j & 1 + j & 1 & 1 & 1 - j & - j & - j & - 1 - j \\ 1 & 1 - j & - j & - 1 - j & - 1 & - 1 + j & j & 1 + j & 1 & 1 - j & - j & - 1 - j & - 1 & - 1 + j & j & 1 + j \\ 1 & 1 - j & - j & - 1 & - 1 + j & j & 1 & 1 - j & - j & - 1 - j & - 1 & j & 1 + j & 1 & - j & - 1 - j \\ 1 & - j & - 1 - j & - 1 & j & 1 & 1 - j & - j & - 1 & j & 1 + j & 1 & - j & - 1 & - 1 + j & j \\ 1 & - j & - 1 & - 1 + j & 1 + j & 1 - j & - j & - 1 & j & 1 & - j & - 1 - j & - 1 + j & 1 + j & 1 & - j \\ 1 & - j & - 1 & j & 1 & - j & - 1 & j & 1 & - j & - 1 & j & 1 & - j & - 1 & j \\ 1 & - j & - 1 & 1 + j & 1 - j & - 1 - j & j & 1 & - j & - 1 & j & 1 - j & - 1 - j & - 1 + j & 1 & - j \\ 1 & - j & - 1 + j & 1 & - j & - 1 & 1 + j & - j & - 1 & j & 1 - j & - 1 & j & 1 & - 1 - j & j \\ 1 & - 1 - j & j & 1 & - 1 - j & j & 1 & - 1 - j & j & 1 - j & - 1 & j & 1 - j & - 1 & j & 1 - j \\ 1 & - 1 - j & j & 1 - j & - 1 & 1 + j & - j & - 1 + j & 1 & - 1 - j & j & 1 - j & - 1 & 1 + j & - j & - 1 + j \\ 1 & - 1 - j & j & - j & - 1 + j & 1 & - 1 & 1 + j & - j & - 1 + j & 1 & - 1 & 1 + j & - j & j & 1 - j \\ 1 & - 1 & 1 + j & - j & j & - j & - 1 + j & 1 & - 1 & 1 & - 1 - j & j & - j & j & 1 - j & - 1 \\ 1 & - 1 & 1 & - 1 - j & 1 + j & - 1 - j & j & - j & j & - j & j & 1 - j & - 1 + j & 1 - j & - 1 & 1\end{matrix} ] .$$

$${F}_{32 , 12} = [ \begin{matrix}1 & 1 & 1 & 1 & 1 & 1 & 1 & 1 & 1 & 1 & 1 & 1 & 1 & 1 & 1 & 1 \\ - 1 & - 1 & - 1 & - 1 + j & - 1 + j & - 1 + j & j & j & j & j & j & 1 + j & 1 + j & 1 + j & 1 & 1 \\ 1 & 1 & 1 - j & - j & - j & - j & - 1 - j & - 1 & - 1 & - 1 & - 1 + j & j & j & j & 1 + j & 1 \\ - 1 & - 1 + j & j & j & 1 + j & 1 & 1 & 1 - j & - j & - 1 - j & - 1 & - 1 & - 1 + j & j & j & 1 + j \\ 1 & 1 - j & - j & - 1 - j & - 1 & - 1 + j & j & 1 + j & 1 & 1 - j & - j & - 1 - j & - 1 & - 1 + j & j & 1 + j \\ - 1 & - 1 + j & j & 1 & 1 - j & - j & - 1 & - 1 + j & j & 1 + j & 1 & - j & - 1 - j & - 1 & j & 1 + j \\ 1 & - j & - 1 - j & - 1 & j & 1 & 1 - j & - j & - 1 & j & 1 + j & 1 & - j & - 1 & - 1 + j & j \\ - 1 & j & 1 & 1 - j & - 1 - j & - 1 + j & j & 1 & - j & - 1 & j & 1 + j & 1 - j & - 1 - j & - 1 & j \\ 1 & - j & - 1 & j & 1 & - j & - 1 & j & 1 & - j & - 1 & j & 1 & - j & - 1 & j \\ - 1 & j & 1 & - 1 - j & - 1 + j & 1 + j & - j & - 1 & j & 1 & - j & - 1 + j & 1 + j & 1 - j & - 1 & j \\ 1 & - j & - 1 + j & 1 & - j & - 1 & 1 + j & - j & - 1 & j & 1 - j & - 1 & j & 1 & - 1 - j & j \\ - 1 & 1 + j & - j & - 1 & 1 + j & - j & - 1 & 1 + j & - j & - 1 + j & 1 & - j & - 1 + j & 1 & - j & - 1 + j \\ 1 & - 1 - j & j & 1 - j & - 1 & 1 + j & - j & - 1 + j & 1 & - 1 - j & j & 1 - j & - 1 & 1 + j & - j & - 1 + j \\ - 1 & 1 + j & - j & j & 1 - j & - 1 & 1 & - 1 - j & j & 1 - j & - 1 & 1 & - 1 - j & j & - j & - 1 + j \\ 1 & - 1 & 1 + j & - j & j & - j & - 1 + j & 1 & - 1 & 1 & - 1 - j & j & - j & j & 1 - j & - 1 \\ - 1 & 1 & - 1 & 1 + j & - 1 - j & 1 + j & - j & j & - j & j & - j & - 1 + j & 1 - j & - 1 + j & 1 & - 1\end{matrix} ] .$$

$${F}_{32 , 21} = [ \begin{matrix}1 & - 1 & 1 & - 1 & 1 & - 1 & 1 & - 1 & 1 & - 1 & 1 & - 1 & 1 & - 1 & 1 & - 1 \\ 1 & - 1 & 1 & - 1 + j & 1 - j & - 1 + j & - j & j & - j & - 1 - j & - j & 1 + j & - 1 - j & 1 + j & - 1 & 1 \\ 1 & - 1 & 1 - j & j & - j & j & - 1 - j & 1 & - 1 & 1 & - 1 + j & - j & j & - j & 1 + j & - 1 \\ 1 & - 1 + j & - j & j & - 1 - j & 1 & - 1 & 1 - j & j & - 1 - j & 1 & - 1 & 1 - j & j & - j & 1 + j \\ 1 & - 1 + j & - j & 1 + j & - 1 & 1 - j & j & - 1 - j & 1 & - 1 + j & - j & 1 + j & - 1 & 1 - j & j & - 1 - j \\ 1 & - 1 + j & - j & 1 & - 1 + j & - j & 1 & - 1 + j & - j & 1 + j & - 1 & - j & 1 + j & - 1 & - j & 1 + j \\ 1 & j & - 1 - j & 1 & j & - 1 & 1 - j & j & - 1 & - j & 1 + j & - 1 + j & - j & 1 & - 1 + j & - j \\ 1 & j & - 1 & 1 - j & 1 + j & - 1 + j & - j & 1 & j & - 1 & - j & 1 & - 1 + j & - 1 - j & 1 & j \\ 1 & j & - 1 & - j & 1 & j & - 1 & - j & 1 & j & - 1 & - j & 1 & j & - 1 & - j \\ 1 & j & - 1 & - 1 - j & 1 - j & 1 + j & j & - 1 & - j & 1 & j & - 1 + j & - 1 - j & 1 - j & 1 & j \\ 1 & j & - 1 + j & - 1 & - j & 1 & 1 + j & j & - 1 & - j & 1 - j & 1 & j & - 1 & - 1 - j & - j \\ 1 & 1 + j & j & - 1 & - 1 - j & - j & 1 & 1 + j & - j & - 1 + j & - 1 & - j & 1 - j & 1 & j & - 1 + j \\ 1 & 1 + j & j & - 1 + j & - 1 & - 1 - j & - j & 1 - j & 1 & 1 + j & j & - 1 + j & - 1 & - 1 - j & - j & 1 - j \\ 1 & 1 + j & j & j & - 1 + j & - 1 & - 1 & - 1 - j & - j & 1 - j & 1 & 1 & 1 + j & j & j & - 1 + j \\ 1 & 1 & 1 + j & j & j & j & - 1 + j & - 1 & - 1 & - 1 & - 1 - j & - j & - j & - j & 1 - j & 1 \\ 1 & 1 & 1 & 1 + j & 1 + j & 1 + j & j & j & j & j & j & - 1 + j & - 1 + j & - 1 + j & - 1 & - 1\end{matrix} ] . \\ and$$

$${F}_{32 , 22} = [ \begin{matrix}1 & - 1 & 1 & - 1 & 1 & - 1 & 1 & - 1 & 1 & - 1 & 1 & - 1 & 1 & - 1 & 1 & - 1 \\ - 1 & 1 & - 1 & 1 - j & - 1 + j & 1 - j & j & - j & j & - j & j & - 1 - j & 1 + j & - 1 - j & 1 & - 1 \\ 1 & - 1 & 1 - j & j & - j & j & - 1 - j & 1 & - 1 & 1 & - 1 + j & - j & j & - j & 1 + j & - 1 \\ - 1 & - 1 - j & j & - j & 1 + j & - 1 & 1 & - 1 + j & - j & 1 + j & - 1 & 1 & - 1 + j & - j & j & - 1 - j \\ 1 & - 1 + j & - j & 1 + j & - 1 & 1 - j & j & - 1 - j & 1 & - 1 + j & - j & 1 + j & - 1 & 1 - j & j & - 1 - j \\ - 1 & 1 - j & j & - 1 & 1 - j & j & - 1 & 1 - j & j & - 1 - j & 1 & j & - 1 - j & 1 & j & - 1 - j \\ 1 & j & - 1 - j & 1 & j & - 1 & 1 - j & j & - 1 & - j & 1 + j & - 1 & - j & 1 & - 1 + j & - j \\ - 1 & - j & 1 & - 1 + j & - 1 - j & 1 - j & j & - 1 & - j & 1 & j & - 1 - j & 1 - j & 1 + j & - 1 & - j \\ 1 & j & - 1 & - j & 1 & j & - 1 & - j & 1 & j & - 1 & - j & 1 & j & - 1 & - j \\ - 1 & - j & 1 & 1 + j & - 1 + j & - 1 - j & - j & 1 & j & - 1 & - j & 1 - j & 1 + j & - 1 + j & - 1 & - j \\ 1 & j & - 1 + j & - 1 & - j & 1 & 1 + j & j & - 1 & - j & 1 - j & 1 & j & - 1 & - 1 - j & - j \\ - 1 & - 1 - j & - j & 1 & 1 + j & j & - 1 & - 1 - j & - j & 1 - j & 1 & j & - 1 + j & - 1 & - j & 1 - j \\ 1 & 1 + j & j & - 1 + j & - 1 & - 1 - j & - j & 1 - j & 1 & 1 + j & j & - 1 + j & - 1 & - 1 - j & - j & 1 - j \\ - 1 & - 1 - j & - j & - j & 1 - j & 1 & 1 & 1 + j & j & - 1 + j & - 1 & - 1 & - 1 - j & - j & - j & 1 - j \\ 1 & 1 & 1 + j & j & j & j & - 1 + j & - 1 & - 1 & - 1 & - 1 - j & - j & - j & - j & 1 - j & 1 \\ - 1 & - 1 & - 1 & - 1 - j & - 1 - j & - 1 - j & - j & - j & - j & - j & - j & 1 - j & 1 - j & 1 - j & 1 & 1\end{matrix} ] .$$

The conjugate transpose of the ADFT can be easily observed as

$${\hat{F}}_{32}^{{}_{{}_{*}}} = {S}_{0}^{T} \cdot {S}_{1}^{T} \cdot {S}_{2}^{T} \cdot {S}_{3}^{T} \cdot {S}_{4}^{*} .$$

Here, the symbol ^{T} represents the transpose operation applied to matrices. This insight can be utilized to embed it into the DVM factorization and derive an approximate DVM.

A factorization can be presented to obtain an approximation for the scaled DVM from 8-point to N-point while reducing the arithmetic complexity. The approximated DVM algorithm of embodiments of the subject invention has linear order multiplication complexity.

Proposition II.3—Let the scaled

$$DVM {Ã}_{N} = {[ {{α}^{kl}}^{} ]}_{k , l = 0}^{N - 1}$$

be defined by nodes {1, α, α2, . . . , α^{N-1}}∈ [symbol] , N=8 or 16, and M=2N (see also Perera et al, 22, supra.). Then, an approximation for the scaled DVM, denoted as Ã_{N}, can be obtained through the following:

$${\hat{A}}_{N} = {{\hat{D}}_{N} [ {J}_{M \times N} ]}^{T} {\hat{F}}_{M}^{{}_{{}_{*}}} {\check{D}}_{32}^{{}_{}} {\hat{F}}_{M}^{{}_{}} {J}_{M \times N} {\hat{D}}_{N} . \qquad ( 2 )$$

Proof. This is trivial from the DVM factorization in Perera et al., 2022 (supra.) followed by Proposition III-B (see also Coelho et al., supra.).

When N=8 and 16, the approximate DFT factorization described in Coelho et al. (supra.) and Mandal et al. (supra.), respectively, can be used. Now, a factorization formula will be presented that can be used to approximate DVM from 32 points and beyond.

Corollary II.4—Let the scaled

$$DVM {\tilde{A}}_{N} = {[ {α}^{kl} ]}_{k , l = 0}^{N - 1}$$

be defined by nodes {1, α,α², . . . , α^{N-1}}∈ [symbol] , N=2^{r}(r≥5), and M=2N. Then, an approximation for the scaled DVM: A_{N} can be obtained via the following:

$${\tilde{A}}_{N} = {{\hat{D}}_{N} [ {J}_{M \times N} ]}^{T} {{F}^{}}_{M}^{*} {\breve{D}}_{M} {\tilde{F}}_{M} {J}_{M \times N} {\hat{D}}_{N} , \qquad ( 3 )$$

$$where {{F}^{}}_{M} = {P}_{M}^{T} [ \begin{matrix}{{F}^{}}_{M} & \\ & {{F}^{}}_{N}\end{matrix} ] {H}_{M} .$$

Proof. This follows immediately from the Proposition (II.3) and approximating DFT matrices by self-contained factors beyond 32-point.

Following the approximated DVM factorization discussed above, embodiments of the subject invention provide approximated scaled DVM algorithms that execute recursively with approximated DFT algorithms, initialized with the 16-point approximated DVM. To further reduce the multiplication counts in computing the matrix-vector product, the factor

$$\frac{1}{\sqrt{M}}$$

### in F_{M} and

$${F}_{M}^{*}$$

can be moved to the end of the computation, and hence y=MÂ_{N}z can be computed. The approximated DVM algorithm has O(N) as opposed to O(N log N) complexity for N=8, 16, 32, 64, 128, 256, 512, 1024.

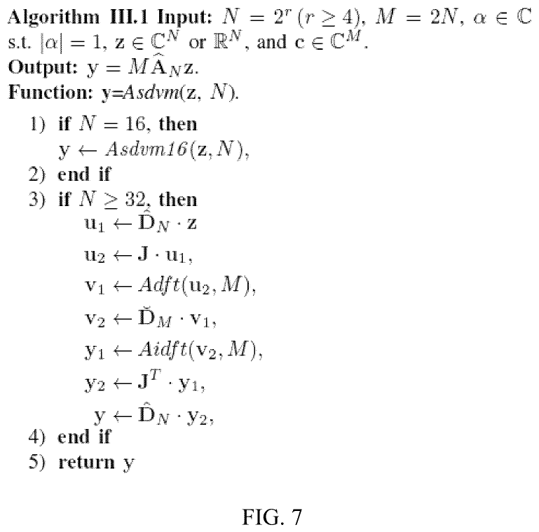

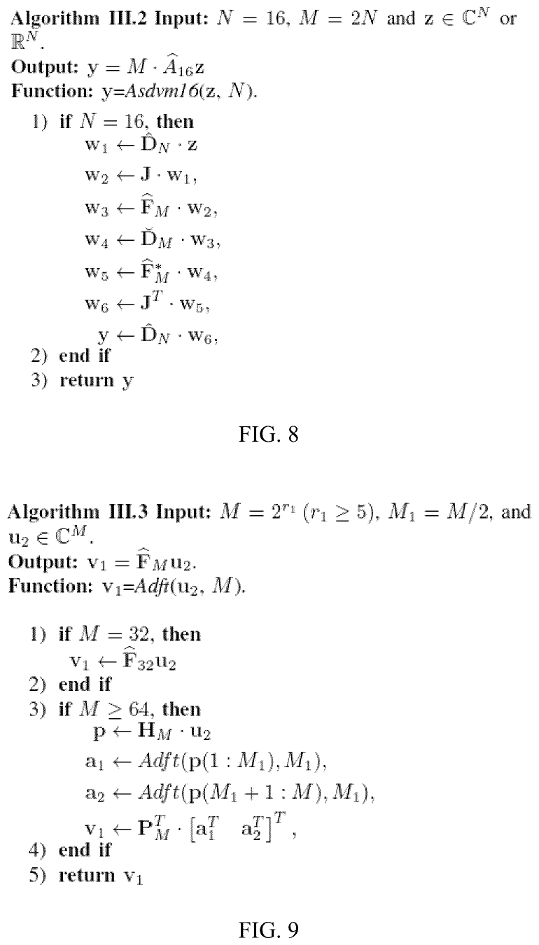

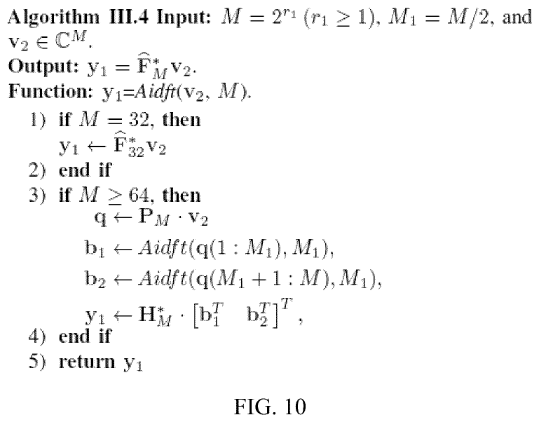

The factorization for the approximate DVM is self-explanatory for N=4, 8, and obtaining the approximate algorithm may not be necessary. FIG. 7 shows an approximated scaled DVM algorithm to compute the product of a scaled DVM by a vector (i.e., y=MÂ_{N}z for a given N, α, z∈ [symbol] or [symbol] and c∈ [symbol] ). The approximated scaled DVM algorithm in FIG. 7 (which can be [symbol] referred to herein as “Asdvm”) can execute recursively initialized with the 16-point approximated DVM followed by the approximate scaled FFTs. The scaled approximate FFT and approximate inverse FFT algorithms (which can be referred to herein as “Adft” and “Aidft”, respectively) are shown in FIGS. 9 and 10, respectively. FIG. 8 shows the 16-point approximate DVM algorithm (which can be referred to herein as “Asdvm16”).

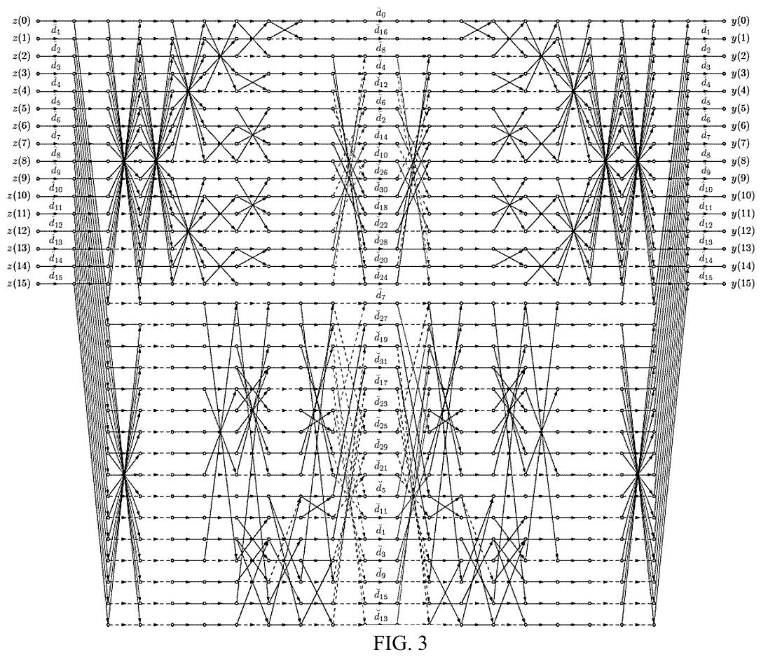

Based on the algorithms shown in FIGS. 7 and 8, building blocks can be shown in the signal flow graph drawn for the 16-point scaled approximated DVM algorithm and shown in FIG. 3. The Asdvm algorithm can be stated based on the sparse factorization in Proposition II.3, and hence the factorization for the scaled approximated DVM can be stated as follows.

$$32 {{A}^{}}_{16} = {\hat{D}}_{16} [ {I}_{16} \vert {0}_{15} ] {{F}^{}}_{32}^{*} {\breve{D}}_{32} {{F}^{}}_{32} [ \frac{{I}_{16}}{{0}_{16}} ] {\hat{D}}_{16} ,$$

$$where {\hat{D}}_{16} = [ \begin{matrix}1 & & & \\ & {\hat{d}}_{1} & & \\ & & ⋱ & \\ & & & {\hat{d}}_{15}\end{matrix} ] ,$$

$${\breve{D}}_{32} = [ \begin{matrix}{\breve{d}}_{0} & & & \\ & {\breve{d}}_{1} & & \\ & & ⋱ & \\ & & & {\breve{d}}_{31}\end{matrix} ] , {{F}^{}}_{32}^{*} := the conjugate transpose$$

of the approximated DFT \hat{F}₃₂, and the sparse factorization for the \hat{F}₃₂ can be obtained from Proposition III-B.

The number of multiplications (say #m) (i.e., gain-delay blocks; see also Perera et al., 2022, supra.) required to compute the algorithm shown in FIG. 7 can be obtained. Counts can be obtained to compute the approximated scaled DVM algorithm, which executes recursively with the scaled approximated FFTs (to reduce the multiplication counts). Thus, the number of [symbol] multiplications required to compute y=\hat{F}_{N}z can be taken, where z∈ [symbol] , as 0 for N=32, when the multiplications by ±1 and ±j are not counted, and Adft and Aidft algorithms can be used to obtain counts to compute y=\hat{F}_{N}z for N>32.

Lemma III.6 Let N=2^{r}(r 4) be given. The approximated scaled DVM algorithm (i.e., Algorithm Asdvm) can recursively be computed using Asdvm16, Adft, and Aidft algorithms with the following gain-delay block counts:

$$\# m ( Asdvm , N ) = 4 N - 2 , for N = 16 \qquad ( 4 )$$

$$\# m ( Asdvm , N ) = 6 N - 6 , for N = 32$$

$$\# m ( Asdvm , N ) = 8 N - 14 , for N = 64$$

$$\# m ( Asdvm , N ) = 10 N - 30 , for N = 128$$

$$\# m ( Asdvm , N ) = 12 N - 62 , for N = 256$$

$$\# m ( Asdvm , N ) = 14 N - 126 , for N = 512$$

$$\# m ( Asdvm , N ) = 16 N - 254 , for N = 1024$$

$$\# m ( Asdvm , N ) = 2 Nr - \frac{17}{4} N + 2 , for N > 1 24.$$

Proof. Referring to the approximated scaled DVM algorithm, we get

$$\# m ( Asdvm , N ) = 2 ( \# m ( {{F}^{}}_{M} ) ) + 2 ( \# m ( {\hat{D}}_{N} ) ) + 2 ( \# m ( J ) ) + \# m ( {\breve{D}}_{M} ) . \qquad ( 5 )$$

Following the structures of \hat{D}_{N}, J, and DM multiplierless the multiplication of each matrix by a complex input, the following is obtained.

$$\# m ( J ) = 0 , \# m ( {\hat{D}}_{N} ) = N - 1 , \# m ( {\breve{D}}_{M} ) = M .$$

Following the approximated DFT factorization for 32-point, and using that with the Adft, and Aidft algorithms, the following counts can be obtained to compute the approximated DFT by a vector (except multiplication by ±1 and ±j): #m (\hat{F}_{M}) 0, N−2, 2N−6, . . . , 6N−126, respectively, for N=16, 32, 64, . . . , 1024. Thus, to compute the approximated DFT by a vector (i.e., y=\hat{F}_{M}u with u∈ [symbol] ), 0 multiplier can be obtained for N=16, and

$$Nr - \frac{33}{8} N + 2$$

multipliers for N≥32. Thus, the multiplication count can be obtained as in (4) above, based on the computation of the approximated scaled DVM algorithm (from FIG. 7).

Based on equations (2) and (4), it can be concluded that the multiplication complexity of the 8-point scaled DVM is also 4N−2 (see also, Coelho et al., supra.).

The approximated scaled DVM algorithm (FIG. 7) has the linear order (i.e. multiplication complexity of O(N)) as opposed to the FFT-like O(N log N) complexity algorithms, for N=16 to 1024. On the other hand, the DVM is an approximated algorithm as opposed to an exact DVM algorithm. The detailed counts are provided in the table in FIG. 4, which shows the numerical results for the multiplication complexity (the gain-delay blocks) of the approximated scaled DVM algorithm in Lemma III.6 compared to the direct matrix-vector computations and the radix-2 exact DVM algorithm. The matrix sizes in the comparison range vary from 16×16 to 1024×1024. Consider the direct computation of the scaled DVM by a vector for gain-delay blocks as (N−1)², where the number of gain-delay blocks being denoted by #m(sdvm) in order to compute the exact scaled DVM algorithm presented in Perera et al., 2022 (supra.). The percentage reduction, P_{A}, and P_{L}, of the gain-delay block counts of the approximated scaled DVM algorithm (FIG. 7) as opposed to O(N log N) complexity exact DVM algorithm in Perera et al., 2022 (supra.) and the brute-force matrix-vector calculation, respectively, can be determined. The values in the last column of the table in FIG. 4 were obtained using

$${P}_{L} = ( \frac{Td - Ta}{Td} ) \times 100 \% ,$$

where Td is the gain-delay block counts in computing the direct matrix-vector product and Ta is the gain-delay block counts in computing the approximated DVM algorithm. The values in the second-to-last column in the table in FIG. 4 were obtained using

$${P}_{A} = ( \frac{Te - Ta}{Te} ) \times 100 \% ,$$

where Te is the gain-delay block counts of the DVM algorithm in Perera et al., 2022 (supra.) and Ta is the gain-dela block counts in computing the approximated DVM algorithm.

The table in FIG. 4 shows that the scaled approximated DVM algorithm requires a significantly low number of gain-delay blocks compared to the brute-force calculation. When the size of the matrices increases, a significant reduction in multiplication complexity (equivalently, delay-gain blocks) can be observed for computing the algorithms of FIGS. 7 and 8. It can also be observed that the scaled approximated DVM algorithm (FIG. 7) has a low number of gain-delay blocks compared to the exact DVM algorithm with O(Nlog N) complexity in Perera et al., 2022 (supra.). Because the radix-2 DVM algorithm was used to execute with the approximated DVM algorithm, it could be observed that the percentage reduction of complexity will be lower when the size of the matrices gets bigger.

The algorithms of many fast transforms often arise from a recursive structure. The FFT has been dubbed the butterfly algorithm, based on the symmetric, butterfly-like patterns that appear when the algorithm is represented visually in a graph. Such graphs illustrate how signals or data are processed at each stage of an algorithm, and so-called signal flow graphs. These graphs are used as a tool to design and improve algorithms and can be utilized as a building block for IC design. Thus, an SFG can be used to denote the 16-point approximated DVM algorithm in FIG. 3. With these SFGs, it is straightforward to verify the multiplication and addition complexity of the algorithm for a given value of N, by simply counting the number of convergences as additions, and the number of elements above the arrows as multiplications, or gain-delay block counts. Therefore, the SFG can be utilized for implementing the 16-point approximated scaled DVM algorithm directly in IC design.

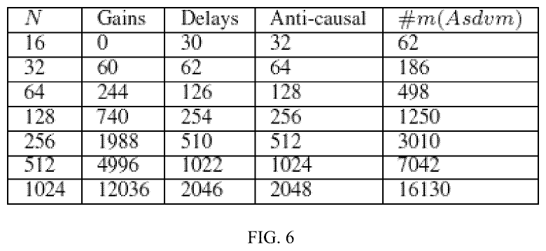

Following the gain-delay blocks in Lemma III.6 and the building blocks of the SFG shown in FIG. 3, the explicit gains (without counting the multiplication by ±1 and ±j), delays, and total multiplication (i.e., gain-delay block counts in computing the scaled approximated DVM algorithm) are shown in the second, third, and last columns, respectively, of the table shown in FIG. 6. The fourth column of the table shows the non-trivial anti-causal counts (see also Perera et al., 2022, supra.), which are equivalent to the number of entries in the pre-computed matrix D̆_{M}. The trivial anti-causal counts arise from the product of the scaled DFT matrix \tilde{F}_{M} by a vector c with entries of the form e^{ikωτ}, where τ is a delay,

$$k = \frac{p}{2}$$

and p is a non-negative integer.

Because these counts are calculated in the pre-computation stage of the algorithm, only the non-trivial anti-causal counts are included in the table in FIG. 6. To realize trivial anti-causal counts (i.e., entries of c), every entry in c was multiplied by the largest magnitude of the anti-casual term

$$( i . e . , \vert α \frac{- {( N - 1 )}^{2}}{2} \vert )$$

in the pre-computation stage so that anti-causal terms are not a problem for practical realizations. To exemplify, consider the simplest transfer function P(ω)=e^{jωτ}+e^{-jωτ}. The same magnitude function can be obtained by modifying P(ω) to P′(ω)=+e^{-2ωτ}, which is simply the original filter with extra latency T.

Multi-beam true time delay beamformers have circuit complexity levels proportional to the number of amplifiers and delay-lines in the multi-beam beamforming network. A direct realization of an N-beam beamformer has amplifier/gain and delay-line complexity proportional to O(N²) for an N-element N-beam system. Embodiments of the subject invention provide an N-point approximated DVM algorithm that utilizes highly sparse factors in an approximate computing framework, reducing the gain-delay complexity of the DVM-vector product to a new low of O(N). The reduction of complexity (e.g., by a further factor of log N) has massive benefits; for example, for 1024 beams, that is a 10-times reduction.

Embodiments can provide N TTD beams on an N-element array at amplifier/gain and delay circuit complexity reduced from the original of O(N²) down to O(N). The approximated DVM algorithm (FIG. 7) executes recursively with the ADFT algorithms (an important aspect), as ADFTs enable reducing DFT complexity down from O(N log N) for usual FFTs to a lower value of O(N), via sparse matrix factorization of the ADFT matrix. An exact FFT (see also Perera et al., 2022, supra.) can be replaced with an O(N) fast-factorized ADFT to reach this remarkable result. The resulting recursion leads to a reduction in the gain-delay complexity of the DVM-vector product to a linear order, which is the first time this has been achieved. The ability to form large numbers of TTD multi-beams over an antenna array aperture having N-elements, with circuit complexity scaling as O(N) (i.e. linear growth), instead of the usual quadratic growth, can significantly enhance the practical realizability of wideband multi-antenna beamforming systems in the future, including mm-Wave and FutureG wireless systems, massive-MIMO (multi-input, multi-output) wireless systems, radar and electronic warfare, and RF imaging applications.

Embodiments of the subject invention provide a focused technical solution to the focused technical problem of how to reduce the complexity of DVMs utilized by TTD multi-beam beamformers. The solution is provided by utilizing an ADVM algorithm (e.g., an N-point ADVM) that utilizes highly sparse factors, thereby reducing the gain-delay complexity (e.g., of the DVM-vector product) from O(N²) (or in some cases O(N log N)) to a linear order (i.e., O(N)).

This technical solution is specific to beamforming technology, addresses a technical problem within the field of beamforming technology, and improves the beamformer itself. Embodiments of the subject invention can improve the beamformer (or computing system comprising the beamformer) itself by reducing the complexity of the DVM, which frees up computing power on the chip (e.g., integrated circuit (IC)) of the beamformer.

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

When the term module is used herein, it can refer to software and/or one or more algorithms to perform the function of the module; alternatively, the term module can refer to a physical device configured to perform the function of the module (e.g., by having software and/or one or more algorithms stored thereon).

When ranges are used herein, combinations and subcombinations of ranges (including any value or subrange contained therein) are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Example 1

In the context of approximations for scaled delay Vandermonde matrices, qualitatively, an approximate scaled DVM, Â_{N}, is a transform matrix such that ŷ=Â_{N}z≈y=Ã_{N}z. In essence, the exact and approximate transform-domain signals are closely related in a quantifiable manner. An approximated matrix must fulfill the following conditions: (i) preserving key properties of the exact matrix; (ii) maintaining mathematical proximity with the exact matrix; and (iii) significantly reducing computational costs compared to the exact DVM-vector product computation.

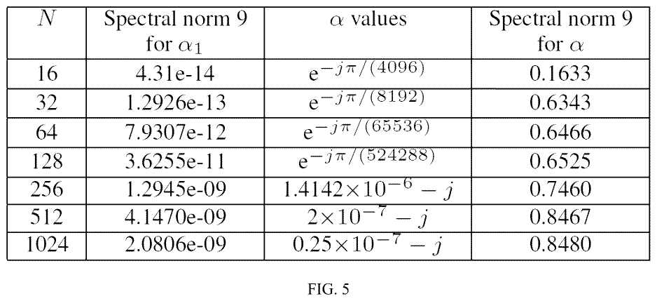

To ensure the accurate interpretation of the approximate spectrum, approximate scaled DVMs can be sought that closely resemble the associated exact scaled DVMs. A way to achieve this is by minimizing the difference between the exact and the approximated scaled DVMs, through a matrix norm. This minimization process should also take into account the constraint of maintaining low complexity. The matrix norms satisfy the equivalence property, so one could spectral (2-norm), Frobenius, which is compatible with the 2-norm of a vector-valued form, 1-norm, or ∞-norm. Thus, a possible minimization problem can be proposed of deriving an approximated scaled DVM for the best possible α∈ [symbol] via

$${min}_{α ∈ ℂ} {‖ {\tilde{A}}_{N} - {\tilde{A}}_{N} ‖}_{2} , \qquad ( 6 )$$

where ∥⋅∥2 is the spectral norm. As a result of this, numerical results will be presented based on the equation (6) to minimize the difference between the exact and the approximated scaled DVMs through the table shown in FIG. 5.

The values in the table shown in FIG. 5 were obtained in the IEEE floating point format with the significant decimal digits precision of 10-16. Thus, for many α, α₁∈ [symbol] values, the approximated DVM shows the proximity to the exact scaled DVM with the minimum spectral norm while preserving the DVM structure along with the execution of the O(N) complexity of the Asdvm16 and Asdvm algorithms. Thus, the countable α∈ [symbol] values in the table in FIG. 5 show that the exact DVM and approximate scaled DVM in the transform-domain signals are closely related in a quantifiable manner.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A beamformer, comprising:
a plurality of antennas;
a plurality of amplifiers respectively connected to the plurality of antennas;
a plurality of filters respectively connected to the plurality of amplifiers; and
a plurality of converters respectively connected to the plurality of filters,
the beamformer being a true time delay (TTD) multi-beam beamformer,
the beamformer utilizing a delay Vandermonde matrix (DVM) to describe delay and sum operations in beamforming of the beamformer, and
the DVM utilized by the beamformer having a complexity of O(N).

2. The beamformer according to claim 1, the plurality of antennas being a plurality of radio frequency (RF) antennas.

3. The beamformer according to claim 1, the plurality of amplifiers being a plurality of low noise amplifiers (LNAs).

4. The beamformer according to claim 1, the plurality of filters being a plurality of low-pass filters (LPFs).

5. The beamformer according to claim 1, the plurality of converters comprising a plurality of analog-to-digital converters (ADCs).

6. The beamformer according to claim 5, the plurality of converters further comprising a plurality of digital-to-analog converters (DACs).

7. The beamformer according to claim 1, the plurality of converters comprising a plurality of digital-to-analog converters (DACs).

8. The beamformer according to claim 1, further comprising a chip electrically connected to the plurality of antennas, the chip running an approximated DVM (ADVM) algorithm.

9. The beamformer according to claim 8, the ADVM algorithm being implemented using at least one approximated discrete Fourier transform (ADFT) algorithm.

10. The beamformer according to claim 1, the beamformer having a sampling rate of at least 64 gigasamples per second (GS/s).

11. The beamformer according to claim 1, the beamformer having a bandwidth of at least 32 gigahertz (GHz).

12. A method of reducing a complexity of a delay Vandermonde matrix (DVM) that is utilized by a beamformer to describe delay and sum operations in beamforming of the beamformer, the method comprising:
providing the beamformer, the beamformer comprising:
a plurality of antennas;
a plurality of amplifiers respectively connected to the plurality of antennas;
a plurality of filters respectively connected to the plurality of amplifiers; and
a plurality of converters respectively connected to the plurality of filters, electrically connecting a chip to the plurality of antennas; and
running an approximated DVM (ADVM) algorithm on the chip in order to reduce the complexity of the DVM utilized by the beamformer to O(N),
the beamformer being a true time delay (TTD) multi-beam beamformer.

13. The method according to claim 12, the ADVM algorithm being implemented using at least one approximated discrete Fourier transform (ADFT) algorithm.

14. The method according to claim 12, the plurality of antennas being a plurality of radio frequency (RF) antennas,
the plurality of amplifiers being a plurality of low noise amplifiers (LNAs), and
the plurality of filters being a plurality of low-pass filters (LPFs).

15. The method according to claim 12, the plurality of converters comprising a plurality of analog-to-digital converters (ADCs).

16. The method according to claim 15, the plurality of converters further comprising a plurality of digital-to-analog converters (DACs).

17. The method according to claim 12, the plurality of converters comprising a plurality of digital-to-analog converters (DACs).

18. The method according to claim 12, further comprising performing sampling using the beamformer,
the beamformer having a sampling rate of at least 64 gigasamples per second (GS/s).

19. The method according to claim 12, the beamformer having a bandwidth of at least 32 gigahertz (GHz).

20. A beamformer, comprising:
a plurality of antennas;
a plurality of amplifiers respectively connected to the plurality of antennas;
a plurality of filters respectively connected to the plurality of amplifiers;
a plurality of converters respectively connected to the plurality of filters; and
a chip electrically connected to the plurality of antennas,
the beamformer being a true time delay (TTD) multi-beam beamformer,
the beamformer utilizing a delay Vandermonde matrix (DVM) to describe delay and sum operations in beamforming of the beamformer,
the plurality of antennas being a plurality of radio frequency (RF) antennas,
the plurality of amplifiers being a plurality of low noise amplifiers (LNAs),
the plurality of filters being a plurality of low-pass filters (LPFs),
the plurality of converters comprising a plurality of analog-to-digital converters (ADCs) and a plurality of digital-to-analog converters (DACs),
the beamformer having a sampling rate of at least 64 gigasamples per second (GS/s),
the beamformer having a bandwidth of at least 32 gigahertz (GHz),
the chip running an approximated DVM (ADVM) algorithm, and
the DVM utilized by the beamformer having a complexity of O(N).
